(19) United States
(12) Patent Application Publication
(10) Pub. No.: US 2006/0145588 A1
(43) Pub. Date: Jul. 6, 2006

(54) Phosphor paste composition comprising phosphate ester as dispersant and display using the same

(75) Inventors: Seul Ki Kim, Gyeonggi-do (KR); Eun Sung Lee, Seoul (KR); Jae Young Choi, Gyeonggi-Do (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Samsung Electronics Co., Ltd., Gyeonggi-do (KR)

(21) Appl. No.: 11/159,140

(22) Filed: Jun. 23, 2005

(30) Foreign Application Priority Data
Jan. 3, 2005 (KR) 2005-0260

(51) Int. Cl. H01J 29/10

(52) U.S. Cl. 313/467

(57) ABSTRACT

A phosphor paste composition, which includes phosphate ester as a dispersant to increase the loading amount of a phosphor without greatly increasing the viscosity, thus improving luminance and maintaining excellent workability. In addition, a display using the phosphor paste composition is provided. The phosphor paste of the current invention is obtained by mixing a binder solution composed of a solvent and a binder with phosphate ester serving as a dispersant and a phosphor, in which the phosphate ester used as the dispersant is phosphate ester of a block copolymer of nonylphenol and polyoxyethyleneglycol or phosphate ester having acryl as a main chain. A preferred phosphor paste is composed of 0.1 to 3 wt % of the phosphate ester serving as a dispersant, 40 to 70 wt % of the phosphor, and the balance being the binder solution.

### BACKGROUND OF THE INVENTION

This non-provisional application claims priority under 35 U.S.C. § 119(a) on Korean Patent Application No. 2005-0000260 filed on Jan. 3, 2005, which is herein expressly incorporated by reference.

1. Field of the Invention

The embodiments of the present invention relate, generally, to a phosphor paste composition including phosphate ester as a dispersant, and a display using the same. More preferably, the embodiments of the present invention relates to a novel phosphor paste composition, in which phosphate ester is used as a dispersant to increase the loading amount of a phosphor without greatly increasing the viscosity, thus improving luminance and maintaining excellent workability, and to a display using the phosphor paste composition.

2. Description of the Related Art

Recently, displays have been developed from conventional cathode ray tubes to plasma display panels (PDPs) or liquid crystal displays (LCDs) having various applications.

The PDP is a flat panel display which uses a phenomenon of converting vacuum ultraviolet rays, emitted from plasma induced upon electric discharge of an inert gas, into red, green and blue light within the visible light range, due to collision with a phosphor screen. Typically, the PDP includes insulating substrates facing each other to form a discharge space therebetween. An inert gas mixture for use in the generation of plasma comprising helium and small amounts of other gases, such as xenon, is contained in the discharge space. Further, the PDP includes electrodes arranged on the inner surfaces of the facing insulating substrates defining the discharge space to form a matrix pattern which partitions the discharge space into a plurality of discharge regions containing the discharge gas. Furthermore, the PDP has a phosphor screen formed at positions where the electrodes intersect and in each discharge region. Therefore, while the plasma is induced from the discharge gas in response to operation signals, vacuum ultraviolet rays are emitted and then excite the phosphor screen, thereby realizing desired light emission.

The LCD includes liquid crystals provided between two substrates (thin glass substrates), a backlight unit and a polarizing sheet. When different voltages are applied between the substrates, the arrangement of liquid crystals is transformed. Thus, whether light emitted from the backlight unit is transmitted is controlled by light switching functions depending on the arrangement of liquid crystals and the polarization direction of the polarizing sheet, generating contrast, to form a display screen, which may be seen with the naked eye of a user. The LCD is mainly used in output devices such as notebook computer monitors.

As such, the displays commonly have a phosphor screen, which is formed by uniformly applying a fluorescent material. To enhance the luminance of the phosphor screen, that is, the luminance of the display, the loading amount of the phosphor should be increased. In addition, the phosphor is provided in a paste state to be applied on the substrate. The phosphor paste is composed mainly of a solvent, a binder, and the phosphor. Further, uniform dispersion of the phosphor requires a dispersant.

Conventionally, phosphor pastes have had no dispersant or have frequently used carboxylic acid as a dispersant. However, such a conventional phosphor paste having no dispersant or having carboxylic acid as a dispersant is disadvantageous because the decrease in viscosity is insignificant, and thus, the loading amount of the phosphor becomes small.

Also, the phosphor included in the phosphor paste is formed mainly of an inorganic material. Hence, if the loading amount of the phosphor is increased, the phosphor screen is difficult to uniformly form due to its high viscosity, thus having reduced workability. Consequently, productivity is lowered.

In this regard, Korean Patent Laid-open Publication No. 2001-96586 discloses a phosphor paste composition and a phosphor screen using the same, in which phosphate ester represented by Formula 1, below, is used as a dispersant. However, the phosphate ester used as a dispersant in the above patent is alkylester of alkylphosphonic acid, which is typically exemplified by methylester of 1-tetradecanephosphonic acid (TDPO) having a low molecular weight of 278.37 and a relatively short tail. Although the dispersant used in the above patent may more efficiently disperse the phosphor than may other conventional dispersants, dispersability is still unsatisfactory.

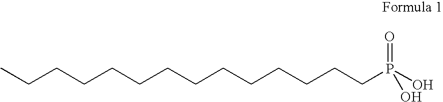

Therefore, the development of techniques for increasing the loading amount of the phosphor while maintaining the viscosity at a predetermined level to exhibit excellent workability are receiving attention as a task which must precede the development of displays manifesting high-quality images due to their improved luminance.

### OBJECTS AND SUMMARY

Accordingly, embodiments of the present invention have been made keeping in mind the above problems occurring in the related art, and an object of embodiments of the present invention is to provide a phosphor paste composition, in which phosphate ester is used as a dispersant, and thus, the loading amount of a phosphor is increased without greatly increasing the viscosity, therefore improving luminance and maintaining excellent workability.

Another object of embodiments of the present invention is to provide a display using the phosphor paste composition.

Embodiments of the present invention provide a phosphor paste composition, comprising a binder solution composed of a solvent and a binder, phosphate ester serving as a dispersant, and a phosphor. The phosphate ester serving as a dispersant is phosphate ester of a block copolymer of nonylphenol and polyoxyethyleneglycol or phosphate ester having acryl as a main chain. The phosphate paste preferably is composed of 0.1 to 3 wt % of the phosphate ester serving as a dispersant, 40 to 70 wt % of the phosphor, and the balance preferably being the binder solution.

### BRIEF DESCRIPTION OF THE DRAWINGS

The above and other objects, features and advantages of embodiments of the present invention will be more clearly understood from the following detailed description taken in conjunction with the accompanying drawings, in which:

FIG. 1 is a graph showing the variation in viscosity depending on the shear rate of a phosphor paste composition having phosphate ester as a dispersant prepared in Example 1 and phosphor paste compositions prepared in Comparative Examples 1 to 7, which have no dispersant or a conventional dispersant;

FIG. 2 is a graph showing the variation in viscosity depending on the loading amount of phosphor powders in a phosphor paste composition having phosphate ester as a dispersant prepared in Example 2 and a phosphor paste composition having no dispersant prepared in Comparative Example 8;

FIG. 3 is a graph showing the light emitting properties of phosphor screens manufactured using each of the phosphor paste composition having phosphate ester as a dispersant prepared in Example 2 and the phosphor paste composition having no dispersant prepared in Comparative Example 8;

FIG. 4 is a graph showing the variation in viscosity of a phosphor paste composition according to embodiments of the present invention depending on the amount of butylcarbitolacetate in a binder solution comprising a solvent and a binder;

FIG. 5 is a graph showing the variation in viscosity of a phosphor paste composition according to embodiments of the present invention depending on the amount of phosphate ester serving as a dispersant and the shear rate;

FIG. 6 is a graph showing the variation in viscosity depending on the shear rate of the phosphor paste composition having phosphate ester as a dispersant prepared in Example 1, a phosphor paste composition having no dispersant (Comparative Example 9) and a phosphor paste composition having a conventional dispersant (Comparative Example 10); and

FIG. 7 is a graph showing the variation in viscosity depending on the shear rate of phosphor paste compositions having phosphate ester as a dispersant prepared in Examples 1 and 3, a phosphor paste composition having no dispersant (Comparative Example 9), and a phosphor paste composition having a conventional dispersant (Comparative Example 10).

### DESCRIPTION OF THE PREFERRED EMBODIMENTS

Hereinafter, a detailed description will be given of embodiments of the present invention, with reference to the appended drawings.

In embodiments of the present invention, when a phosphor paste for use in the formation of a phosphor screen is prepared, phosphate ester is used as a dispersant to increase the loading amount of a phosphor in the phosphor paste without increasing the viscosity of the paste. Hence, the luminance of a display can be improved due to the high amount of the phosphor.

In addition, the phosphor paste including phosphate ester as a dispersant of embodiments of the present invention is composed of a solvent, a binder, and a phosphor, which are components equal or similar to those used for the preparation of conventional phosphor pastes. That is, the binder solution comprising an organic binder and a solvent is mixed with the phosphor and phosphate ester serving as a dispersant that is able to increase the loading amount of the phosphor while decreasing the viscosity, to prepare the phosphor paste for use in the formation of phosphor screen for various displays, such as PDPs or LCDs.

If the amount of the phosphate ester serving as a dispersant is less than 0.1 wt %, the phosphor is insufficiently dispersed, and thus, an increase in the loading amount of the phosphor and a decrease in viscosity are generally not realized. On the other hand, if the above amount exceeds 5 wt %, other components are used in relatively decreasing amounts, resulting in diminishing physical properties of the resultant paste.

In embodiments of the present invention, phosphate ester serving as a dispersant is added, so that the amount of phosphor is remarkably increased to 40 to 70 wt %. Further, the increase in the loading amount of the phosphor included in the phosphor paste leads to high luminance of the phosphor screen obtained using such a paste.

The binder solution includes the organic binder and the solvent mixture. As such, the preferred organic binder includes a cellulose based polymer, such as ethyl cellulose, and the solvent mixture preferably contains terpineol and butylcarbitolacetate (BCA). The preferred organic binder included in the binder solution is known to be commercially available cellulose based polymers, such as ethyl cellulose. In addition, as the solvent included in the binder solution, commercially available solvents may be used alone or in combinations thereof. The solvent is selected in consideration of the physical properties of the phosphor, the organic binder and the resultant phosphor paste, which is easily understood by those skilled in the art.

Preferably, the binder solution includes 1.5 to 5 wt % of the organic binder, with the balance being the solvent mixture. If the organic binder is used in an amount less than 1.5 wt %, the amount of the solvent is larger than that of the organic binder, and the resultant phosphor screen generally has poor properties, such as low quality, due to the lack of organic binder. On the other hand, if the organic binder is used in an amount exceeding 5 wt %, the amount of the solvent is relatively decreased, thus reducing the loading amount of the phosphor.

In the solvent mixture, terpineol and BCA are mixed at a weight ratio of 1:1 to 1:2.5, preferably 1:1.7. Such a solvent mixture is understood as a solvent system suitable to control the viscosity of the resultant phosphor paste to about 50,000 cps, which is a value that has been experimentally found to make work processes, such as coating, easy, so as to realize excellent workability.

The phosphor includes commercially available red phosphors, green phosphors and blue phosphors, which are in the form of solid solutions of oxide fundamentally used in displays. Preferably, the phosphor in the form of a solid solution of a mixture comprising barium oxide, magnesium oxide and aluminum oxide may be used.

Further, the phosphor paste of embodiments of the present invention is manufactured into a phosphor screen for displays according to a typical process used by display manufacturers. Since the loading amount of the phosphor per unit area is greatly increased due to the use of phosphate ester as a dispersant, the luminance of the phosphor screen is considerably improved without a large increase in viscosity, and thus, the fabrication of the phosphor screen becomes easier.

The phosphor screen of embodiments of the present invention is used as a phosphor screen for known displays such as PDPs or LCDs, to provide displays manifesting higher luminance.

A better understanding of embodiments of the present invention may be obtained in light of the following examples and comparative examples which are set forth to illustrate, but are not to be construed to limit the present invention.

### EXAMPLE 1

0.51 g of ethyl cellulose serving as an organic binder, and 4.61 g of terpineol and 7.68 g of BCA serving as a solvent were mixed together to prepare a binder solution, which was then mixed with 0.14 g of phosphate ester of a block copolymer of nonylphenol and polyoxyethyleneglycol (RE610, available from Toho Chemical Co. Ltd., Japan) serving as a dispersant, represented by Formula 2, below, and 24 g of commercially available blue phosphor powders, to obtain a phosphor paste:

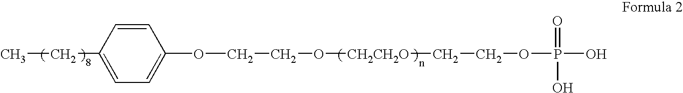

### COMPARATIVE EXAMPLES 1 TO 7

A phosphor paste was prepared in the same manner as in Example 1, with the exception that the dispersant was not used, and the blue phosphor powders were used without change (Comparative Example 1). In addition, respective phosphor pastes were prepared in the same manner as in Example 1, with the exception that oleyol sarcosine (Comparative Example 2), oleyol acid (Comparative Example 3), oleyol amine (Comparative Example 4), oleyol alcohol (Comparative Example 5), TEGO630 (Comparative Example 6, Degussa, Netherlands), and AFB1521 (Comparative Example 7, NOF Corporation, Japan) were used as a conventional dispersant, instead of the phosphate ester of embodiments of the present invention.

### EXPERIMENTAL EXAMPLE 1

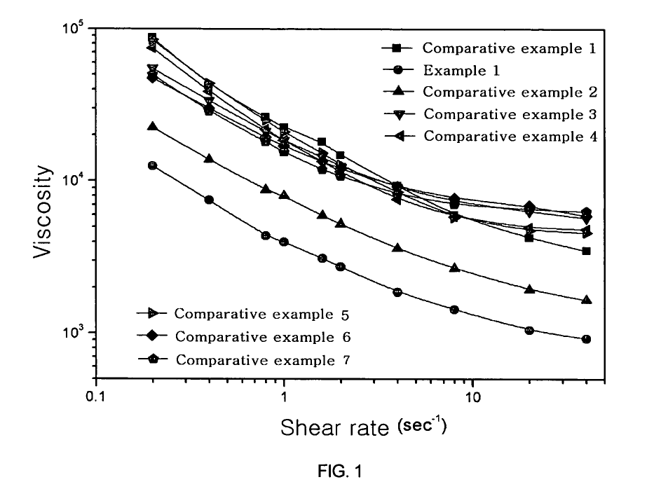

The viscosities of the phosphor pastes prepared in Example 1 and Comparative Examples 1 to 7 were measured. The results are shown in FIG. 1. As such, variations in viscosity to shear rate were measured by use of an RV-II apparatus (Brookfield, USA) at 24.5 to 25.5° C. for 30 sec at each shear rate using a No. 14 spindle.

As is apparent from FIG. 1, the phosphor paste including phosphate ester as a dispersant prepared in Example 1 is confirmed to have much lower viscosity than other pastes prepared in Comparative Examples 1 to 7. Hence, the loading amount of the phosphor can be further increased, which means that the resultant phosphor screen, when applied to displays, can exhibit higher luminance.

### EXAMPLE 2

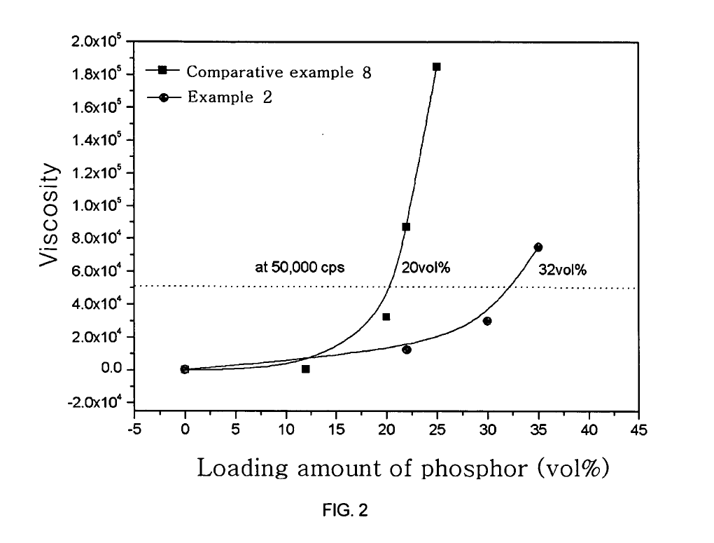

To the binder solution used in Example 1, 0.14 g of phosphate ester serving as a dispersant were added. Subsequently, the amount of phosphor added to the reaction solution to set the viscosity of the resultant paste at 50,000 cps was measured. The results are shown in FIG. 2.

### COMPARATIVE EXAMPLE 8

A phosphor paste was prepared in the same manner as in Example 2, with the exception that the dispersant was not used. The results are given in FIG. 2.

As shown in FIG. 2, the phosphor paste including phosphate ester as a dispersant as in Example 2 has about 32 vol % of the phosphor based on the total volume of the phosphor paste, which is about 160% more than 20 vol % of the phosphor in the phosphor paste having no dispersant as in Comparative Example 8.

Thus, the loading amount of the phosphor can be further increased, which means that the resultant phosphor screen, when applied to displays, can manifest higher luminance.

### EXAMPLE 3

0.51 g of ethyl cellulose serving as an organic binder, and 4.61 g of terpineol and 7.68 g of BCA, serving as a solvent, were mixed together to prepare a binder solution, which was then mixed with 0.14 g of phosphate ester of acryl ester block copolymer (BYK 111, available from BYK-Chemie GmbH, Germany) serving as a dispersant, represented by Formula 3, below, and 14 g of commercially available blue phosphor powders, to obtain a phosphor paste:

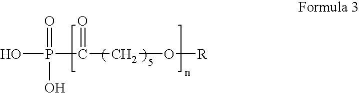

Wherein R is an oxyethylenemethacryloyl group, an oxyethylacryloyl group, a polyoxypropylmethacryloyl group, or a polyoxyethylmethacryloyl group.

In an embodiment of the present invention, the phosphate ester of acryl ester block copolymer represented by Formula 3 in which R is an oxyethylenemethacryloyl group was used.

### EXPERIMENTAL EXAMPLE 2

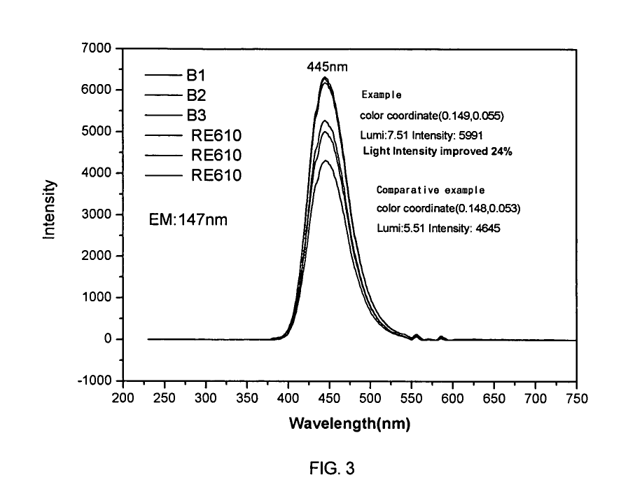

The phosphor pastes prepared in Example 2 and Comparative Example 8 were manufactured into phosphor screens according to a typical process, after which light emitting properties of each phosphor screen were measured. The light emitting experiment was performed using PEDS (Phosphor of Emission and Decay measurement System, which is an assembly of a VUV excimer lamp available from USHIO, Japan, and a vacuum chamber system available from Motech vacuum, Korea), under conditions of a vacuum atmosphere of 10 to 3 torr, a light source of a wavelength of 146 nm, a measurement wavelength range from 230 to 780 nm, and an interval between wavelengths of 1 nm. The results are shown in FIG. 3. As such, the phosphor pastes obtained in Example 2 and Comparative Example 8 were each used in the manufacture of three phosphor screen samples, the light emitting properties of which were then measured and represented by the corresponding curves.

From FIG. 3, it can be shown that the phosphor screen sample having phosphate ester as a dispersant according to the present invention has a main emission peak from 400 to 500 nm, which is the wavelength range emitting blue light, a maximum emission intensity at 445 nm, and has almost the same color coordinates as Comparative Example (Example 2: 0.149, 0.055, Comparative Example 8: 0.148, 0.053). The paste of Example 2 (5991) can emit light about 130% stronger than can the paste of Comparative Example (4645). Even if the luminance is increased, other light properties are seldom changed, thus excellent color reproducibility is demonstrated. Therefore, it appears that the phosphor screen of embodiments of the present invention may be used as a phosphor screen for displays, such as PDPs or LCDs, without change.

### EXPERIMENTAL EXAMPLE 3

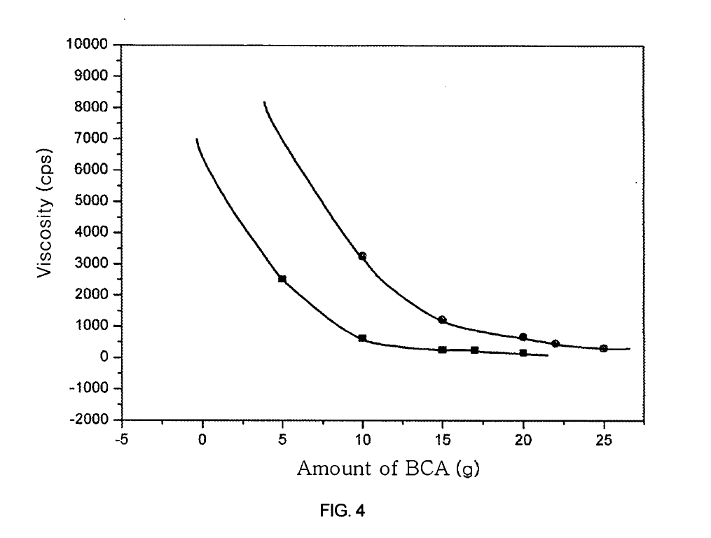

To measure the decrease in viscosity varying with the amount of BCA included in the binder solution of the paste composition of the present invention, a terpineol solution of 10% ethyl cellulose and a terpineol solution of 15% ethyl cellulose were prepared, and then the viscosity was measured in varying the amount of BCA as shown in Table 1, below. The results are shown in FIG. 4.

TABLE 1

| Variation in Amount of | | | |
|---|---|---|---|
| BCA in Solution (10 wt %) | | Amount of | Total wt % of |
| BCA | Total Amount of Solution | EC in Final | EC in Final |
| (g) | (EC + Terpineol + BCA) | Solution (g) | Solution (%) |
| 0 | 10 | 1 | 10 |
| 5 | 15 | 1 | 6.67 |
| 10 | 20 | 1 | 5 |
| 15 | 25 | 1 | 4 |
| 20 | 30 | 1 | 3.33 |
| 25 | 35 | 1 | 2.86 |

*EC: ethylcellulose
*BCA: butylcarbitolacetate

As shown in FIG. 4, the viscosity was confirmed to decrease as the amount of BCA of the binder solution was increased. After the BCA was added in a predetermined amount or more, the decrease in viscosity was insignificant. From this, the mixing ratio by weight of terpineol and BCA greatly affecting the decrease in viscosity can be found to be 1:1.7.

As is apparent from Table 1, in the solution including 10 g of a terpineol solution of ethyl cellulose and 15 g of BCA, the weight ratio of terpineol to BCA is 9 g to 15 g, which corresponds to 1:1.7.

### EXPERIMENTAL EXAMPLE 4

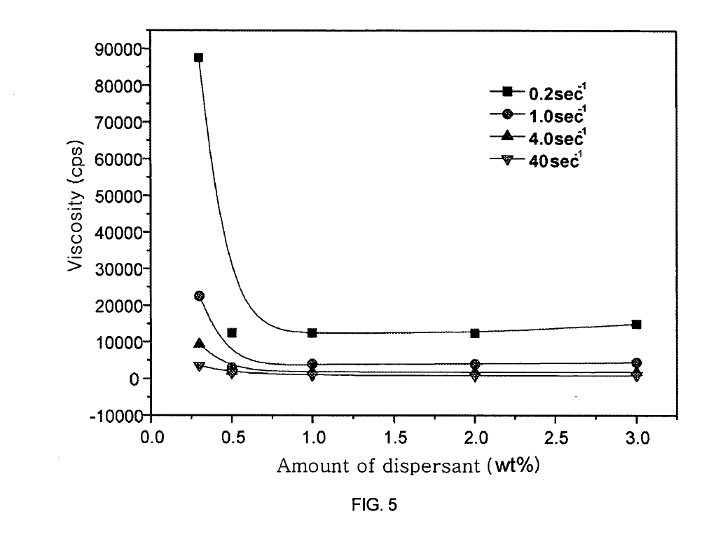

To measure the viscosity varying with the amount of phosphate ester serving as a dispersant in the paste composition and the shear rate, each composition was prepared with varying amounts of dispersant (0.07 g corresponding to 0.5 wt %, 0.14 g corresponding to 1.0 wt %, 0.21 g corresponding to 1.5 wt %, 0.28 g corresponding to 2.0 wt %, and 0.35 g corresponding to 3 wt %, in FIG. 5). The viscosity of each composition was measured as the shear rate was varied. The results are depicted in FIG. 5.

As in FIG. 5, when the phosphate ester was used as a dispersant, the viscosity of the composition was confirmed to drastically decrease upon initial use. Then, even if more dispersant is added, the decrease in viscosity is not large. Thus, it appears that the viscosity of the composition drastically decreases even if only a small amount of phosphate ester serving as a dispersant is added, and also, the viscosity uniformly decreases as the shear rate increases. From this, it can be confirmed that the viscosity is actually not affected by the shear rate, and the composition having a large amount of phosphor may easily be prepared by mixing.

### EXPERIMENTAL EXAMPLE 5

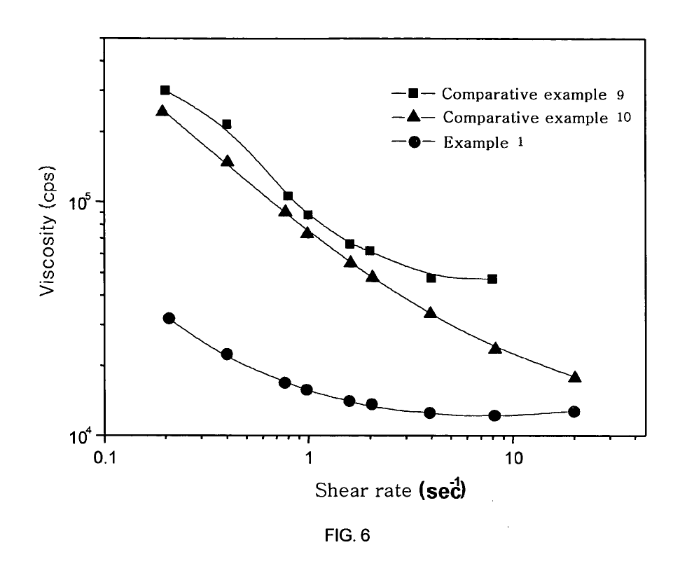

Variation in viscosity depending on the shear rate of each of the paste composition of Example 1, a paste composition without a dispersant, which is a control, of Comparative Example 9, and a paste composition having a conventional dispersant (TDPO) of Comparative Example 10 were measured. The results are given in FIG. 6. As such, the paste compositions of Example 1 and Comparative Example 10 were each composed of the same amounts of the same solvent, phosphor and other components, and the same amount of the dispersant, provided that the type of dispersant was different in each case.

As shown in FIG. 6, the paste composition having phosphate ester as a dispersant according to embodiments of the present invention exhibits a greater decrease in viscosity, compared to the control having no dispersant of Comparative Example 9 and the composition having a conventional dispersant of Comparative Example 10. Also, it can be seen that the viscosity of the paste composition of embodiments of the present invention tended to be much lower than those of the compositions of Comparative Examples 9 and 10, as the shear rate was increased.

### EXPERIMENTAL EXAMPLE 6

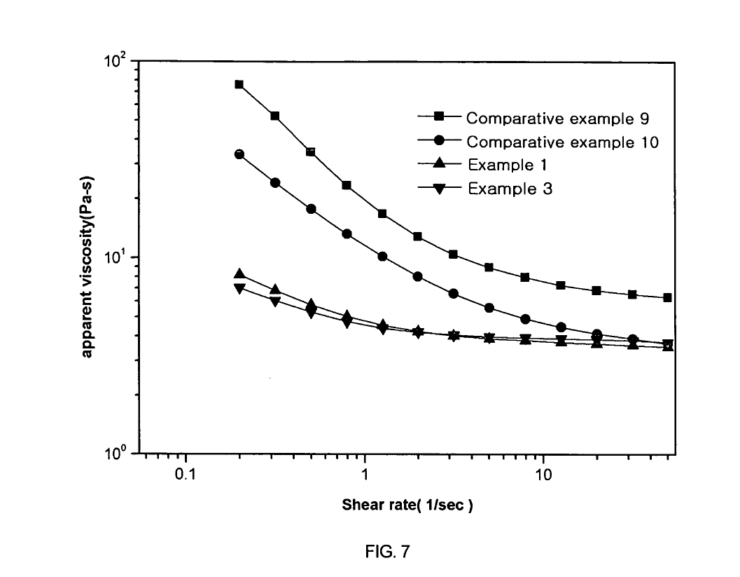

Variation in viscosity depending on the shear rate of each of the paste compositions of Examples 1 and 3, the paste composition without a dispersant, which is a control, of Comparative Example 9, and the paste composition having a conventional dispersant (TDPO) of Comparative Example 10 were measured. The results are depicted as variation in apparent viscosity in FIG. 7. As such, the paste compositions of Examples 1 and 3 and Comparative Example 10 were each composed of the same amounts of the same solvent, phosphor and other components, and the same amount of the dispersant, provided that the type of dispersant was different in each case.

As shown in FIG. 7, the paste compositions having phosphate ester as a dispersant according to embodiments of the present invention manifest a greater decrease in viscosity, compared to the control having no dispersant of Comparative Example 9 and the composition having a conventional dispersant of Comparative Example 10. Further, it can be seen that the viscosities of the paste compositions of embodiments of the present invention tended to be much lower than those of the compositions of Comparative Examples 9 and 10, as the shear rate was increased.

As described hereinbefore, the embodiments of the present invention provide a novel phosphor paste composition including phosphate ester as a dispersant and a display using the phosphor paste composition. In the embodiments of the present invention, since phosphate ester is used as a dispersant, the loading amount of the phosphor is increased without greatly increasing the viscosity, thus increasing the luminance and maintaining excellent workability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A phosphor paste composition, comprising
(i) a binder solution comprising a solvent and a binder,
(ii) 0.1 to 3 wt % of a phosphate ester serving as a dispersant, and
(iii) 40 to 70 wt % of a phosphor,
in which the phosphate ester serving as a dispersant is a phosphate ester of a block copolymer of nonylphenol and polyoxyethyleneglycol or a phosphate ester having acryl as a main chain.

2. The phosphor paste composition according to claim 1, wherein the phosphate ester having acryl as a main chain is represented by Formula 3: 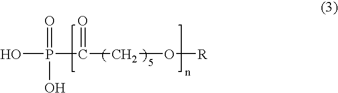
wherein R is an oxyethylmethacryloyl group, an oxyethylacryloyl group, a polyoxypropylmethacryloyl group, or a polyoxyethylmethacryloyl group.

3. The phosphor paste composition according to claim 1, wherein the solvent in the binder solution is a solvent mixture and the binder in the binder solution is an organic binder.

4. The phosphor paste composition according to claim 2, wherein the solvent mixture is a solvent mixture comprising terpineol and butylcarbitolacetate, and the organic binder is a cellulose based polymer.

5. The phosphor paste composition according to claim 3, wherein the organic binder is ethyl cellulose.

6. The phosphor paste composition according to claim 2, wherein the binder solution is comprised of 1.5 to 5 wt % of the organic binder.

7. The phosphor paste composition according to claim 3, wherein the solvent mixture comprises terpineol and butylcarbitolacetate mixed at a weight ratio of 1:1 to 1:2.5.

8. The phosphor paste composition according to claim 1, wherein the phosphor is in a form of a solid solution of a mixture comprising barium oxide, magnesium oxide and aluminum oxide.

9. A phosphor screen for displays, manufactured using the phosphor paste composition of claim 1.

10. A display, comprising the phosphor screen of claim 9.
